(19) United States
(12) Patent Application Publication
(10) Pub. No.: US 2025/0354832 A1
(43) Pub. Date: Nov. 20, 2025

(54) METHOD FOR CALIBRATING AN INERTIAL MEASUREMENT SENSOR SYSTEM OF A VEHICLE

(71) Applicant: MERCEDES-BENZ GROUP AG, Stuttgart (DE)

(72) Inventors: Sinan YARGELDI, Dettingen an der Erms (DE); Anton NELSON, Ammerbuch (DE)

(21) Appl. No.: 18/869,416

(22) PCT Filed: Mar. 31, 2023
(86) PCT No.: PCT/EP2023/058568

§ 371 Date: Nov. 26, 2024

(30) Foreign Application Priority Data
May 30, 2022 (DE) 10 2022 001 883.7

(51) Int. Cl. G01C 25/00; B60Q 1/14; B60Q 11/00

(52) U.S. Cl. CPC G01C 25/005; B60Q 1/143; B60Q 11/005; B60Q 2300/11; B60Q 2300/132

(57) ABSTRACT

An inertial measurement sensor system of a vehicle is calibrated during a driving operation of the vehicle and is based on a determination of a misalignment of a sensor coordinate system of the inertial measurement sensor system with respect to a vehicle coordinate system. The determination of the misalignment is interrupted in situations in which a level deviation from a reference level exceeding a predetermined threshold value is determined by means of at least one of the vehicle's own level sensors.

### BACKGROUND AND SUMMARY OF THE INVENTION

Exemplary embodiments of the invention relate to a method for calibrating an inertial measurement sensor system of a vehicle, as well to a method for the headlamp range control of at least one headlight of a motor vehicle.

It is known that MEMS-based (MEMS=Micro Electro Mechanical Systems) inertial measurement sensor systems are installed in vehicles, which measure a rotation rate as a rotation rate sensor and an acceleration of the vehicle in up to three spatial directions as an accelerometer or acceleration sensor. The inertial measurement sensor systems are used for various vehicle systems, such as vehicle dynamics control, modern augmented reality applications, and assisted or automated driving.

However, the recordings from such inertial measurement sensor systems can be subject to errors, which can lead to a limitation of usability or achievable system accuracy in many applications that use these recordings. Such sensor errors are, for example, incorrect alignment of the respective inertial measurement sensor system to the vehicle and offset errors of individual measurement axes. The offset errors represent an intrinsic error of the inertial measurement sensor system, which is reflected in the fact that not only is a current acceleration or rotation rate output, but rather a measured value xₘₑₐₛ also has a constant, slowly changing offset x_{offset}(t) compared to a real value xᵣₑₐₗ according to

$${x}_{meas} = {x}_{real} + {x}_{offset} ( t ) . \qquad ( 1 )$$

It is known that such offset errors are determined internally in vehicles via a long-term comparison of measured values. It is assumed that over a relatively long time horizon, the sums of the accelerations, since the vehicle starts at 0 km/h and stops at 0 km/h, and rotation rates, since the vehicle does not roll over head-first or sideways, are equal to zero. A deviation in the measured values must therefore largely originate from offset components x_{offset estimation} of the inertial measurement sensor systems, which can therefore also be estimated and subtracted from the future measured values according to

$${x}_{meas} = {x}_{real} + {x}_{offset} ( t ) - {x}_{offset estimation} \approx {x}_{real} . \qquad ( 2 )$$

However, external influences such as a change in the position of the vehicle, for example due to changing pitch or roll angles, can mean that these assumptions are no longer valid. It is also not possible to reliably determine a value for a yaw rate offset in this way, as the vehicle can theoretically be travelling in an infinite stationary circle. Therefore, information from other sensors, such as wheel speed sensors, must be consulted in order to obtain a reference value for an existing yaw situation.

Due to the offset influence of gravity caused by the misalignment of the inertial measurement sensor system to the vehicle coordinate system, the offset error estimation already attempts to compensate for the effect of the installation position of the sensor. As the amount of gravity is known from the position of the vehicle on the earth, excess acceleration amounts in a stationary situation are offset-related. However, as the offset per sensor axis can vary greatly, it is still not possible to achieve completely correct gravitational compensation and therefore offset determination.

For a more precise and comprehensive calibration of the respective inertial measurement sensor system, a special measurement set-up is required that provides predefined accelerations and rotation rates on the inertial measurement sensor system for the offset calibration and provides a tared, horizontal surface for an alignment calibration, in which acceleration directions of both gravity and the vehicle are defined in the vehicle coordinate system. This means that the inertial measurement sensor system can be virtually rotated accordingly, although this is very time-consuming and costly.

A method for determining the misorientation of sensors in a sensor cluster of a vehicle is known from DE 10 2005 033 237 A1. The sensor cluster has either three linear acceleration sensors or three rotation rate sensors. Desired installation directions of the sensors in relation to coordinate axes of a Cartesian coordinate system fixed to the vehicle are predetermined, wherein the actual installation directions of the sensors can deviate from the desired installation directions due to misorientations. By comparing values measured by the sensors under different conditions with values known for these different conditions in the Cartesian coordinate system fixed to the vehicle, the actual installation directions of the sensors are determined.

From DE 10 2015 115 282 A1, a method is known for determining an orientation of an inertial measurement sensor system of a vehicle with respect to a vehicle coordinate system, in which a first sensor signal of the inertial measurement sensor system is detected in an acceleration-free state of the vehicle, a second sensor signal of the inertial measurement sensor system is detected in a linearly accelerated state of the vehicle, and the orientation is determined based on the first and second sensor signals. The first sensor signal is used to find a vertical alignment of the inertial measurement sensor system based on the gravitational acceleration and the second sensor signal is used to determine a rotation of the inertial measurement sensor system about a vertical axis of the vehicle.

A method for calibrating an inertial measurement sensor system of a vehicle is known from DE 10 2004 045 890 A1, wherein the inertial measurement sensor system is designed as a simple acceleration sensor for measuring a vertical acceleration of the vehicle. It is intended to determine a deflection state of the vehicle when the vehicle is stationary and to store it as a reference value. The deflection state of the vehicle is continuously determined while the vehicle is in driving operation, and as soon as the measured deflection state corresponds to the deflection state stored as reference value, a quiescent value of the simple acceleration sensor is set to a predetermined value.

A method for adjusting a dipped beam of a vehicle is known from CN 1 08 819 831 A, wherein a light adjustment unit receives acceleration and angular velocity data from an inertial measurement sensor system and receives vehicle information via a data bus. The light adjustment unit determines a pitch angle of the vehicle from the information received and adjusts an illumination distance of the dipped beam depending on the pitch angle.

A method for determining a tilt state of a vehicle with respect to a road surface is known from WO 2017/129 199 A1, wherein the determination is carried out by means of a titling model using measured values and wherein the measured values are determined using an inertial measurement sensor system.

A method for monitoring a state of the vehicle is known from US 2013/0166099 A1, in which measured values are detected by means of an inertial measurement sensor system during driving operation of the vehicle and scanned over a period of time and in which a rotation matrix is determined using the measured values, which represents an offset between an alignment of the inertial measurement sensor system and an actual alignment of the vehicle.

A method for calibrating an inertial measurement sensor system of a vehicle is known from EP 3 171 134 A1, wherein sensor data of the inertial measurement sensor system are recorded at two stationary positions of the vehicle at different vehicle alignments and wherein, furthermore, sensor data of the inertial measurement sensor system are recorded while driving straight ahead at a constant speed, during cornering to the right and during cornering to the left, and wherein misalignments and offsets with respect to a vehicle coordinate system are determined using the recorded sensor data.

Exemplary embodiments of the invention are directed to a novel method for calibrating an inertial measurement sensor system of a vehicle and a novel method for the headlamp range control of at least one headlight of a vehicle.

In the method according to the invention for calibrating an inertial measurement sensor system of a vehicle, the calibration takes place during driving operation of the vehicle. The calibration is based on the determination of a misalignment of a sensor coordinate system of the inertial measurement sensor system with respect to a vehicle coordinate system, wherein the determination of the misalignment is interrupted in situations in which a level deviation exceeding a predetermined threshold value with respect to a reference value is detected by means of at least one of the vehicle's own level sensors.

In order for inertial measurement sensor systems based on acceleration sensors to be able to provide a correct angle between the vehicle and a driving surface plane, such as a road surface, information about the installed inertial measurement sensor system is required. Depending on the sensor package, the installation position on a circuit board and the orientation of a corresponding control unit in the vehicle, different, for example rotated, accelerations are measured. These measurements must be internally rotated back into the orientation of the vehicle body, i.e., the vehicle coordinate system, using information from a previous calibration. Since the present method can be used to differentiate between vehicle pitch angles and sensor installation rotations, both of which have an identical effect on measurements, the method makes it possible to calibrate the inertial measurement sensor system automatically and independently. This eliminates the need for costly and time-consuming calibrations under controlled conditions, in which either the vehicle pitch angles or sensor installation rotations must be known and which therefore cannot be carried out in the field. This is particularly advantageous in the case of vehicle construction in the factory or sensor replacement, as such costly and time-consuming calibrations under controlled conditions can be omitted.

By means of the present method, the calibration procedure can be significantly simplified by using the vehicle's own level sensor, which is installed on a rear axle of the vehicle, for example, to control the calibration. This means that a self-calibration procedure can be started after the vehicle has been built or a sensor replacement has taken place, which attempts to recognize the installation position of the inertial measurement sensor system relative to a body plane, i.e., relative to the vehicle coordinate system, in the next driving situations. A static rotation between the vehicle coordinate system, in particular a plane spanned by a transverse axis and a longitudinal axis of the vehicle, and the sensor coordinate system, in particular a plane spanned by a transverse axis and a longitudinal axis of the sensor, can now be calculated iteratively.

The method thus enables control of an automated online calibration of the inertial measurement sensor system in a vehicle according to tangible and comprehensible criteria and prevents the influence of undefined scenarios on a calibration result, such as a static pitch and/or roll angle change. Depending on the expansion stage of the respective inertial measurement sensor system, for example characterized by a number of measurement axes of an acceleration sensor and rotation rate sensor of the inertial measurement sensor system, various error components, i.e., the misorientations and offsets of the sensor coordinate system, can be calibrated. No additional hardware components are required for this, which reduces material and cost expenditure as well as installation space requirements.

In a possible embodiment of the method, the calibration is carried out in a predetermined period of time while the vehicle is in driving operation.

In a possible embodiment of the method, the misalignment of the sensor coordinate system with respect to the vehicle coordinate system is determined using a static pitch angle determined from an alignment of a longitudinal axis of the sensor coordinate system to a longitudinal axis of the vehicle coordinate system. The static pitch angle can be used to easily and reliably determine situations of the vehicle that have a major influence on sources of error in the calibration and can therefore be reliably excluded during calibration.

In a further possible embodiment of the method, the vehicle coordinate system is defined in such a way that a plane spanned by a transverse axis and a longitudinal axis of the vehicle runs parallel to a driving surface plane under predetermined normal conditions.

In a further possible embodiment of the method, an acting gravitational acceleration is estimated using a determined alignment of the sensor coordinate system, using map data from a digital road map, in particular a geographical altitude and a road inclination, and using an inclination of the vehicle to a driving surface plane. While the vehicle is in driving operation, a comparison occurs during time periods without further acceleration between the acceleration measured by the inertial measurement sensor system and the estimated gravitational acceleration, and an offset of the inertial measurement sensor system with respect to the acceleration measurement is determined based on the results of the comparison. This enables a particularly reliable and precise determination of the offset of the inertial measurement sensor system with respect to the acceleration measurement.

In a further possible embodiment of the method, map data from a digital road map is used to check whether there is a change in the inclination of the driving surface plane in a predetermined section, and an optical environment detection sensor system is used to check that profile changes on the driving surface plane do not exceed a predetermined threshold value in a predetermined section. The inertial measurement sensor system is used to determine a rotation of the vehicle in space and the level sensor is used to determine a relative rotation of the vehicle in relation to a driving surface plane. If there is no change in the inclination of the driving surface plane and profile changes on the driving surface plane do not exceed the predetermined threshold value, an offset of a rotation rate sensor of the inertial measurement sensor system is determined by comparing the rotation determined by the inertial measurement sensor system with the relative rotation determined by the level sensor. This enables a particularly reliable and precise determination of the offset of the rotation rate sensor of the inertial measurement sensor system.

In a further possible embodiment of the method, the calibration is based on recording and analyzing a plurality of values of longitudinal acceleration and lateral acceleration of the vehicle over the predetermined time period and can therefore be carried out particularly easily and reliably.

In a further possible embodiment of the method, long-term average values are formed from the recorded values of the longitudinal acceleration and lateral acceleration of the vehicle, and the calibration is carried out using these long-term average values. This represents a further simplification of the method.

In a further possible embodiment of the method, the calibration is based on at least one learning algorithm and can therefore be automatically adapted to different situations in the vehicle and thus optimized.

In the method according to the invention for the headlamp range control of at least one headlight of a vehicle, an inertial measurement sensor system is calibrated according to a method described above, wherein an alignment of the vehicle relative to a driving surface plane is determined by means of the calibrated inertial measurement sensor system and the headlamp range of the headlight is controlled depending on the determined alignment. The calibration of the inertial measurement sensor system and use thereof in the method for the headlamp range control enables a compensation for changes in the headlamp range caused by the vehicle accelerating.

Exemplary embodiments of the invention are explained in more detail below with reference to the drawings.

### BRIEF DESCRIPTION OF THE DRAWING FIGURES

Here are shown:

FIG. 1 schematically, a vehicle, a vehicle coordinate system, a sensor coordinate system and a driving surface with a surface coordinate system, and,

FIG. 2 schematically, a learning curve of a sensor installation angle.

Parts corresponding to one another are labelled with the same reference numerals in all figures.

### DETAILED DESCRIPTION

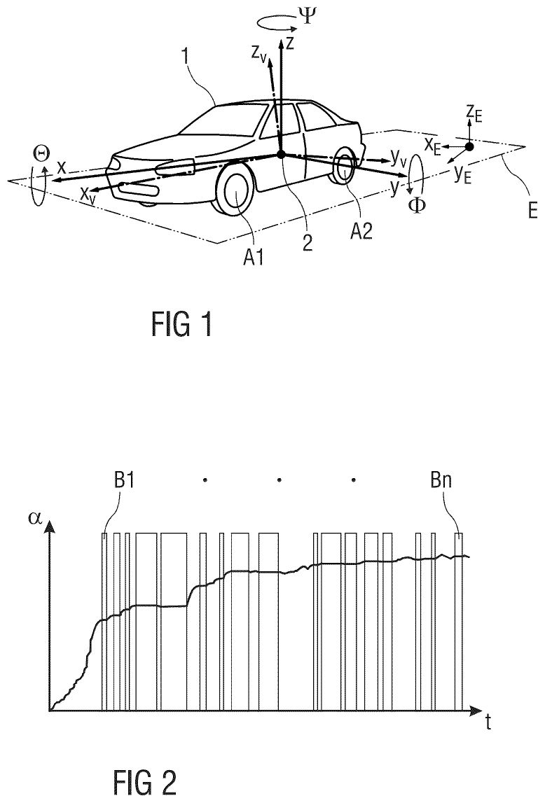

FIG. 1 illustrates a vehicle 1, in particular a land vehicle, a Cartesian vehicle coordinate system, a Cartesian sensor coordinate system, and a driving surface, in particular a driving surface plane E, with a Cartesian surface coordinate system.

The vehicle coordinate system is fixed to a body of the vehicle 1 and has a transverse axis yᵥ, a longitudinal axis xᵥ and a vertical axis zᵥ. An origin of the vehicle coordinate system is located, in particular, in the center of gravity of the vehicle 1. The vertical axis zᵥ points upwards parallel to the normal vector of a cabin floor and cabin roof, the longitudinal axis xᵥ points parallel to a longitudinal vehicle axis and perpendicular to the aforementioned normal vector, and the transverse axis yᵥ points parallel to a transverse vehicle axis, also perpendicular to the aforementioned normal vector.

The surface coordinate system also has a transverse axis y_{E}, a longitudinal axis x_{E} and a vertical axis z_{E}.

The sensor coordinate system is assigned to an inertial measurement sensor system 2 of the vehicle 1 and also has a transverse axis y, a longitudinal axis x and a vertical axis z.

The misalignment of the inertial measurement sensor system 2, which is used, for example, to operate an anti-lock braking system, a vehicle dynamics control system, and/or other application purposes, results from a rotation of the sensor coordinate system in relation to the vehicle coordinate system. The reasons for this are, for example, incorrect orientation of sensor axes in a sensor package of the inertial measurement sensor system 2 by a sensor manufacturer, incorrect alignment on a control unit board of the inertial measurement sensor system 2, twisted mounting in the control unit housing, or twisted attachment of the housing of the inertial measurement sensor system 2 to the vehicle body. In reality, all components simultaneously play a role in the misalignment of the inertial measurement sensor system 2 to the vehicle coordinate system.

The rotation of the inertial measurement sensor system 2 describing the misalignment can be described by a sequence of three rotations θ, ϕ, ψ, which can be regarded as roll, pitch, and yaw angles. However, accelerations in the vehicle coordinate system are required for various dynamic-vehicle controls and tasks, for example vehicle dynamics control, in order to be able to perform a correct calculation.

Calibration is required for reliable and precise operation of the inertial measurement sensor system 2, wherein the sources of error of the inertial measurement sensor system 2 to be detected in the calibration represent, amongst other things, the misalignment of the sensor coordinate system with respect to the vehicle coordinate system due to packaging, installation and assembly, an offset of an acceleration sensor of the inertial measurement sensor system 2, and an offset of a rotation rate sensor of the inertial measurement sensor system 2. This calibration makes it possible to rotate the inertial measurement sensor system 2 back to the orientation of the vehicle 1, i.e., the orientation of the vehicle coordinate system.

It is assumed that all the respective sensor axes of the inertial measurement sensor system 2 (transverse axis y, longitudinal axis x, vertical axis z) are perpendicular to each other and that the coordinate systems of a rotation rate sensor of the inertial measurement sensor system 2 and an acceleration sensor of the inertial measurement sensor system 2 match.

The present idea of calibration is, for example, an evaluation of acceleration directions that occur for the vehicle 1. For a basic calibration, a basic state of the vehicle 1 is defined, which is to be used for the calibration. In particular, this basic state is characterized in that an adult driver is in the vehicle 1 and a fuel tank is half full. Other situations with a large load and passengers are now detected by at least one level sensor installed on an axis A1, A2 of the vehicle 1 and, for example, seat occupancy mats, and excluded for the calibration.

This means that in the automatically controlled calibration of the inertial measurement sensor system 2, rotational states of the vehicle 1 are recognized with the aid of at least one level sensor, which is not shown in detail. Misorientations and offsets of the sensor coordinate system of the inertial measurement sensor system 2 are determined, and the calibration is carried out during a driving operation of the vehicle 1 for a predetermined period of time. In the calibration, a misalignment of the sensor coordinate system with respect to the vehicle coordinate system is determined, wherein the determination of the misalignment is interrupted in situations during driving operation in which a level deviation from a reference level exceeding a predetermined threshold value is detected by means of the vehicle's own level sensor.

The misalignment of the sensor coordinate system with respect to the vehicle coordinate system is determined using a static pitch angle α determined from an alignment of the longitudinal axis x of the sensor coordinate system to the longitudinal axis xᵥ of the vehicle coordinate system and shown in more detail in FIG. 2. As already explained, the vehicle coordinate system is defined in such a way that its, which is spanned by the longitudinal axis xᵥ and transverse axis yᵥ under normal conditions, i.e., normal loading of the vehicle, for example, runs parallel to the driving surface plane E. An actual static pitch angle α is therefore equal to zero. The pitch angle α is measured in the sensor coordinate system.

If the measured static pitch angle α is not equal to zero, then the sensor coordinate system is rotated relative to the vehicle coordinate system. The measured static pitch angle α indicates by how many degrees the sensor coordinate system is rotated about the pitch axis in relation to the vehicle coordinate system. The pitch angle α therefore corresponds to the misalignment of the longitudinal axis x of the sensor coordinate system with respect to the longitudinal axis xᵥ of the vehicle coordinate system.

Furthermore, the aforementioned information can be combined with highly accurate map data in order to obtain an estimate of an acting gravitational acceleration by means of a current geographical altitude, an inclination of the driving surface and an inclination of the vehicle to this driving surface. This allows a comparison to be made between an acceleration measured by the inertial measurement sensor system 2 and the estimated gravitational acceleration during time periods without further accelerations in order to obtain the offset of the acceleration sensor of the inertial measurement sensor system 2 according to:

measured acceleration=gravitation+vehicle acceleration+inertial forces+offset.

The time periods without further acceleration can, for example, be detected by wheel speed sensors and a wheel lock angle, wherein it is assumed that there is no vehicle acceleration at constant wheel speed and that there are no inertial forces if no wheel lock angle and no change in rotation are detected by level sensors.

Furthermore, it is possible to compare a measured rotation of the vehicle body between the rotation rate sensor and the level sensor. It should be noted here that the systems measure different rotations. The rotation rate sensor measures a complete rotation of the vehicle 1 in space, whereas the level sensor only measures a relative rotation in relation to the driving surface plane E.

Therefore, it must be ensured for the comparison that an inclination of the driving surface plane E does not change and a surface of the driving surface plane E does not have any coarse profile changes, for example due to speed bumps and/or potholes. Movements that fulfil these criteria are purely acceleration-induced, also brake-induced, pitching and rolling movements of the vehicle 1. The high-precision map data can then be used to check whether the inclination of the driving surface plane E was constant in a predetermined section. The evenness of the surface of the driving surface plane E is checked using data from an optical environment detection sensor system, for example a camera and/or a lidar. Only when these conditions are met are the measured values used for an offset calibration of the rotation rate sensor of the inertial measurement sensor system 2.

Depending on the existing inertial measurement sensor system 2, which are already present in the vehicle 1 for vehicle dynamics control and other driver assistance systems, for example, the costs can be minimized and a corresponding combination can be selected depending on the desired accuracy and redundancy of the system.

FIG. 2 represents a learning curve of a learned sensor installation angle, in particular a learned pitch angle α, depending on a driving time t. Furthermore, ranges B1 to Bn are represented in which the values of the level sensor are used according to the description above in order to interrupt the calibration and thus the learning process of the pitch angle α during the driving operation of the vehicle 1.

This means that the calibration process is paused in situations where the chassis situation of the vehicle 1 has changed, for example if there is a large load and therefore a static constant pitch angle α, which would otherwise be incorporated in the calibration.

Other sources of error are, for example, vehicle tensions in stopping situations with the brake applied or on slopes with a large inclination, which also lead to static pitch angles α. These situations can also be recognized efficiently using the information from the level sensor.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method comprising:
determining, during a driving operation of a vehicle comprising an inertial measurement sensor system and a level senor, a misalignment of a sensor coordinate system of the inertial measurement sensor system with respect to a vehicle coordinate system;
determining, during the driving operation of the vehicle using the level sensor of the vehicle, whether a level deviation from a reference level exceeds a predetermined threshold value; and
calibrating, based on the determined misalignment, the inertial measurement sensor system during the driving operation of the vehicle and interrupting the calibration when it is determined that the level deviation from the reference level exceeds the predetermined threshold value.

12. The method of claim 11, wherein the determination of the misalignment of the sensor coordinate system with respect to the vehicle coordinate system is based on a static pitch angle determined from an alignment of a longitudinal axis of the sensor coordinate system with a longitudinal axis of the vehicle coordinate system.

13. The method of claim 11, wherein the vehicle coordinate system is defined in such a way that a plane spanned by a transverse axis of the vehicle and a longitudinal axis of the vehicle runs parallel to a driving surface plane under predetermined normal conditions.

14. The method of claim 11, further comprising:
estimating an acting gravitational acceleration based a determined alignment of the sensor coordinate system, map data from a digital road map, and an inclination of the vehicle with respect to a driving surface plane;
comparing, during the driving operation of the vehicle in time periods without further acceleration, an acceleration measured by the inertial measurement sensor system with the estimated gravitational acceleration; and
determining, based on the comparing, an offset of the inertial measurement sensor system with respect to the acceleration measured by the inertial measurement sensor system.

15. The method of claim 14, further comprising:
checking, using map data of a digital road map, whether there is a change in an inclination of the driving surface plane in a predetermined section, and checking, using an optical environment detection sensor system of the vehicle, that profile changes of the driving surface plane do not exceed a predetermined threshold value in the predetermined section;
determining, using the inertial measurement sensor system, a rotation of the vehicle in space;
determining, using the level sensor, a relative rotation of the vehicle in relation to the driving surface plane; and
if there is no change in the inclination of the driving surface plane and the profile changes of the driving surface plane do not exceed the predetermined threshold value, an offset of a rotation rate sensor of the inertial measurement sensor system is determined by comparing the rotation determined by the inertial measurement sensor system with the relative rotation determined by the level sensor.

16. The method of claim 11, wherein the calibration is performed during driving operation of the vehicle in a predetermined time period.

17. The method of claim 16, wherein the calibration is based on a recording and evaluation of a plurality of values of a longitudinal acceleration and lateral acceleration of the vehicle performed in the predetermined time period.

18. The method of claim 17, wherein long-term average values are formed from the plurality of recorded values of the longitudinal acceleration and lateral acceleration of the vehicle and the calibration is performed using the long-term average values.

19. The method of claim 11, wherein the calibration is based on at least one learning algorithm.

20. A method comprising:
calibrating an inertial measurement sensor system of a vehicle, which comprises a level sensor by
determining, during a driving operation of a vehicle comprising an inertial measurement sensor system and a level senor, a misalignment of a sensor coordinate system of the inertial measurement sensor system with respect to a vehicle coordinate system;
determining, during the driving operation of the vehicle using the level sensor of the vehicle, whether a level deviation from a reference level exceeds a predetermined threshold value; and
calibrating, based on the determined misalignment, the inertial measurement sensor system during the driving operation of the vehicle and interrupting the calibration when it is determined that the level deviation from the reference value exceeds the predetermined threshold value;
determining, using the calibrated inertial measurement sensor system, an alignment of the vehicle relative to a driving surface plane; and
controlling a range of a headlight of the vehicle depending on the determined alignment.
